(19) United States
(12) Patent Application Publication
(10) Pub. No.: US 2003/0075035 A1
(43) Pub. Date: Apr. 24, 2003

(54) Bagpipe drone reed

(76) Inventors: Geoff Ross, Victoria (AU); Robert Crozier, Victoria (AU)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 09/999,629

(22) Filed: Oct. 24, 2001

(51) Int. Cl. G10D 7/00

(52) U.S. Cl. 84/380 B

(57) ABSTRACT

A bagpipe reed system is disclosed. A reed seat body is substantially tubular and includes a bleed hole through one side. An open end is attachable to a bagpipe drone or chanter. A planar reed substantially overlies the bleed hole and is held at one end by a reed mount to the reed seat body. The reed seat body has an external reed seat surface around the bleed hole which is shaped such that the planar reed diverges from the reed seat body. The reed seat surface is preferably a curved plane. A reed pitch adjuster is preferably mounted to the reed seat surface.

### FIELD OF THE INVENTION

The present invention relates to improved bagpipe drone reed system with a construction able to be used with synthetic reeds but not limited to such reeds.

### BACKGROUND OF THE INVENTION

The origins of the bagpipe can be traced back to the most ancient civilizations. The bagpipe probably originated as a rustic instrument in many cultures. A herdsman had the necessary materials at hand of a goat or sheepskin and a reed pipe. The instrument is also mentioned in the Bible. Historians believe that the bagpipe originated in Sumaria and through Celtic migration was introduced to Persia and India, and onto Greece and Rome.

Bagpipes have always been made in many shapes and sizes. The basic form, from which all modern types evolved, consists of four parts:

(1) a tube called a chanter, with as many as eight finger holes and is usually fitted with a reed, enabling a melody to be played, inserted into

(2) an airtight bag that holds the instrument's supply of wind,

(3) another tube equipped with a valve which the player traditionally blows into the bag but prevents the return of air and

(4) one or more drone pipes extending from the bag and fitted with a reed enabling a tuned sound to harmonise with the played melody.

Medieval pipes usually had a single drone pipe such as the English single-drone pipes shown in the illustrations of Chaucer's Canterbury Tales. Later shepherd-style pipes acquired a second drone. A third drone was added after about 1600 AD. There was also the advent of small, quiet chamber pipes such as the French shuttle-drone models with some blown with bellows under the arm rather than with the mouth. Contemporary bagpipes can have as many as seven tubes emanating from the instrument's body—the chanter and up to six other tubes called drones, which provide a continuous harmony. These tubes are fitted with reeds either single or double.

Modern instruments have bags usually made of either sheepskin, which is tanned, cut, and sewn, or of rubberized fabric. The modern player produces air either by blowing into the bag through a tube or by operating a small set of bellows with the player's arm. The construction of the bagpipe allows a continuous supply of air to be maintained. By squeezing the bag with one hand while a breath is taken, the flow of air can be kept up in both the drone pipes and chanter. Other features of this instrument are the mouthpiece and the double reed of the chanter and drone. The mouthpiece can contain a round piece of leather hinged onto the bag end, which acts as the one-way valve. The chanter usually has seven finger holes and a thumbhole, and therefore has a usual range of an octave and one note.

Reeds or this woodwind instrument have, until recently, been fashioned from natural material, such as bamboo. This really available material produces a warm, harmonically pleasing sound, but is subject to deterioration over relatively short periods due to the harsh humid playing conditions.

Bagpipe drone reeds have usually been produced by utilizing a hollow piece of bamboo tubing, sealed at one end and open at the opposing end. A “tongue” or elongated three-sided flap of bamboo is cut from the body of the tube. This tongue vibrates and produces a tone from airflow pushed around the tongue. The reed vibrates to produce a tone that is amplified by the body of the reed. The tongue is attached at one end to a flat surface of the body. A fixed bridle attaches the end. The unattached or free end of the tongue is positioned directly above a small air bleed orifice extending through the wall of the body. The length of the tongue is altered by means of the “bridle” or loop of cord or other material, which surrounds the body of the reed. The bridle can be moved along the tube to alter pitch (a longer tongue will produce a lower pitch and a shorter tongue will produce a higher pitch).

Always the tongue has been curved to enable the vibration. Air under pressure supplied by the piper, is allowed to pass through the air bleed orifice of the body and pass the tongue, and out the seat of the reed. A movable bridle surrounds the tubular body and the tongue is movable for tone adjustment. The proximity of the bridle to a bend in the tongue determines the spacing of the free end of the tongues from the air bleed orifice. This controls the tone of the sound produced by the reed.

Other materials have been used instead of bamboo in an attempt to match the sound and performance of bamboo drone reeds in bagpipes. These materials have included injection-moulded plastics, polymers, composites, and light alloy metals such as aluminium and brass, and have been used for both the body of the reed (the tube) and the tongue. These materials have been difficult to use since they also were always formed into a curved tongue.

The construction of the bagpipe has therefore followed very traditional routes, not only as a matter of tradition but due to the particular constructional constraints of the bagpipes, which is so different to other musical instruments. Technical variations of other instruments have not transcended into bagpipe construction. Further, the specialist construction of bagpipes by the less than 100 manufacturers worldwide have only produced two readily located U.S. patent documents being U.S. Pat. No. 4,838,141 and U.S. Pat. No. 5,959,226.

U.S. Pat. No. 4,838,141 a pipe bag is constructed from a flexible composite material, which is airtight but readily permits, the transmission of moisture vapour. At least one layer of the flexible composite material is a continuous hydrophilic layer. When a moisture vapour concentration gradient is present across said hydrophilic layer it transfers substantial amounts of water through the layer by absorbing water on the side of the layer at which the higher water vapour concentration exists, and desorbing water on the opposite side of the layer at which the water vapour concentration is lower. As a result of this, the moisture concentration within the bag is regulated.

U.S. Pat. No. 5,959,226 discloses a design for providing a substitute to a bamboo reed incorporates a wood-based, polymer body and two thin plastic tongues, regulated by a short length of synthetic tubing (the bridle). A brass or plastic tube is strewed or pressed in one end to form the “seat” of the reed, or that portion which is pressed into the bagpipe itself An opposite end of the tubular body includes a tuning pin to change a pitch of the reed. The bagpipe reed is fashioned from a hollow tube as a body, threaded or tapered at both ends to provide for the use of a threaded or tapered plug (tuning pin) at either end, employed to adjust airflow and pitch. The tuning pin is a socket headed cap screw having external threads at one end and an enlarged, knurled head at the opposite end. The head includes a hexagonal shaped opening for rotation of the tuning pin into and out of the tubular body by an Allen wrench. The opposite end of the tubular body includes a treaded and tapered reed seat or moveable insertion base for the reed. The reed seat may be externally threaded at one end and include wrapped waxed threads in a tapered, conical configuration at the opposite end. The reed seat is moulded to include a plurality of ridges to assist in gripping waxed thread wrapped around the reed seat.

These patents are merely modifications of the traditional methods and still make it extremely difficult to use the benefits of modern materials.

### SUMMARY OF THE INVENTION

In accordance with the invention there is provided a bagpipe reed system comprising a reed seat body being substantially tubular with a bleed hole along one side and an open end connected or attachable to a bagpipe drone or chanter, and a planar reed substantially overlying the bleed hole and held at one end by a reed mount to the reed seat body, with the reed seat body having an external reed seat surface around the bleed hole is shaped such that the planar reed diverges from the reed seat body.

The invention also provides a bagpipe reed system comprising a reed seat body being substantially tubular with a bleed hole along one side and an open end connected or attachable to a bagpipe drone or chanter, and a reed substantially overlying the bleed hole and held at one end by a reed mount to the reed seat body and the reed system including a reed pitch adjustor mounted on the reed seat body and contacting an under surface of the reed and adjustable to move the reed away from the reed seat body to adjust the pitch.

It can be seen that the invention overcomes a particular problem of having to shape a carbon graphite reed to the traditional bent shape. Instead a range of reed materials can be used to make a planar reed while the body of the reed seat is curved. In addition, the invention includes a means of adjustment of the distance of the reed from the reed body to allow ready tuning of the pitch of the instrument.

These and other objects of the invention, a well as many of the intended advantages thereof will become more readily apparent when reference is made to the following description taken in conjunction with the accompanying drawings.

### BRIEF DESCRIPTION OF THE DRAWINGS

FIG. 1 is a plan view of a bagpipe reed system of the present invention.

FIG. 2 is an exploded plan view of the bagpipe reed system located adjacent to a bagpipe drone.

FIG. 3 is a side view of a first embodiment of a bagpipe reed system of the present invention.

FIG. 4 is a side view of a second embodiment of a bagpipe reed system of the present invention.

FIG. 5 is a side view of a third embodiment of a bagpipe reed system of the present invention.

FIG. 6 is a side view of a fourth embodiment of a bagpipe reed system of the present invention.

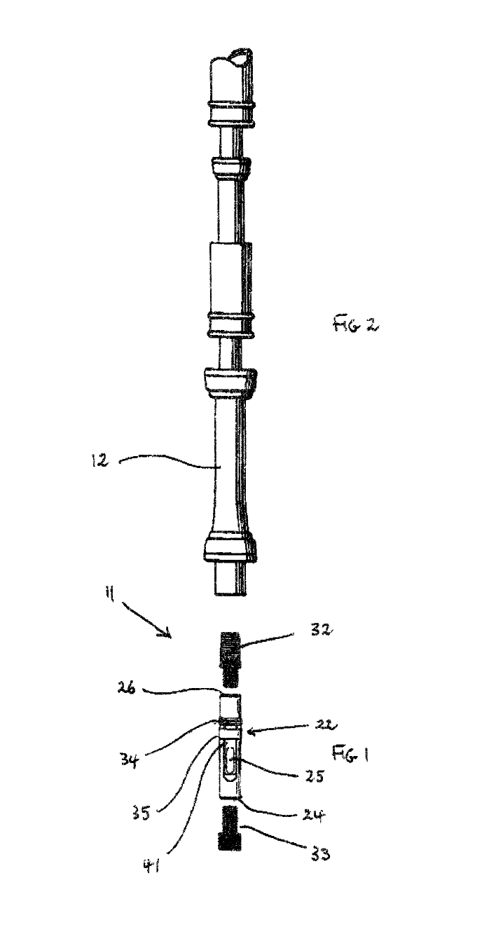

### DETAILED DESCRIPTION OF THE PREFERRED EMBODIMENTS

Referring to the drawings there is shown a bagpipe reed system 11, which includes a reed seat body 22 and a planar reed 41. The reed seat body 22 is substantially tubular with an extended oval bleed hole 25 along one side and an open end 26 connected or attachable to a bagpipe drone 12 or chanter 13 (not shown). The reed 41 substantially overlies the bleed hole 25 and is held at one end by an encircling fixed reed mount 34 to the reed seat body.

The reed seat body 22 has an external reed seat surface 23 around the bleed hole 25 and is shaped such that the planar reed 41 diverges from the reed seat body 22.

In one form shown in FIG. 3 this is achieved by the reed seat body 22 being substantially tubular around a central axis of rotation and the external reed surface23 extending along the reed seat body 22 inwardly towards the central axis of rotation such that the planar reed 41 mounted over the bleed hole 25 extends away from the reed seat body 22. The standard sizes and dimensions of various makes of bagpipes determine the length, diameter, and wall thickness of the main tubular body. A preferred wall thickness is 3/32 inch, with an inner diameter of ¼ inch and an outer diameter of 7/16 inch,

One end 24 of the tubular body 22 has a tuning plug 33 threadably mounted in end 24 of tubular body 20 to vary the pitch of the bagpipe reed. End 24 is internally threaded to matingly receive the external threads of the tuning plug 33. The threaded end of the tuning plug 33 is solid to block escaping of air from end 24 of the tubular body 22. At the opposite end 26 of the tubular body 22 is reed body mount 32. The reed body mount 32 is externally threaded to engage with internal threads of the end 26 of the tubular body 22. The outer shape of the reed body mount is tapered at an angle so that the diameter is approximately 7 millimetres, tapering inwardly from point having a diameter of approximately 9 millimetres. These diameters can include a layer of wrapped material or thread, which extends around the reed body mount for providing a functional fit with a bagpipe drone or canter as required.

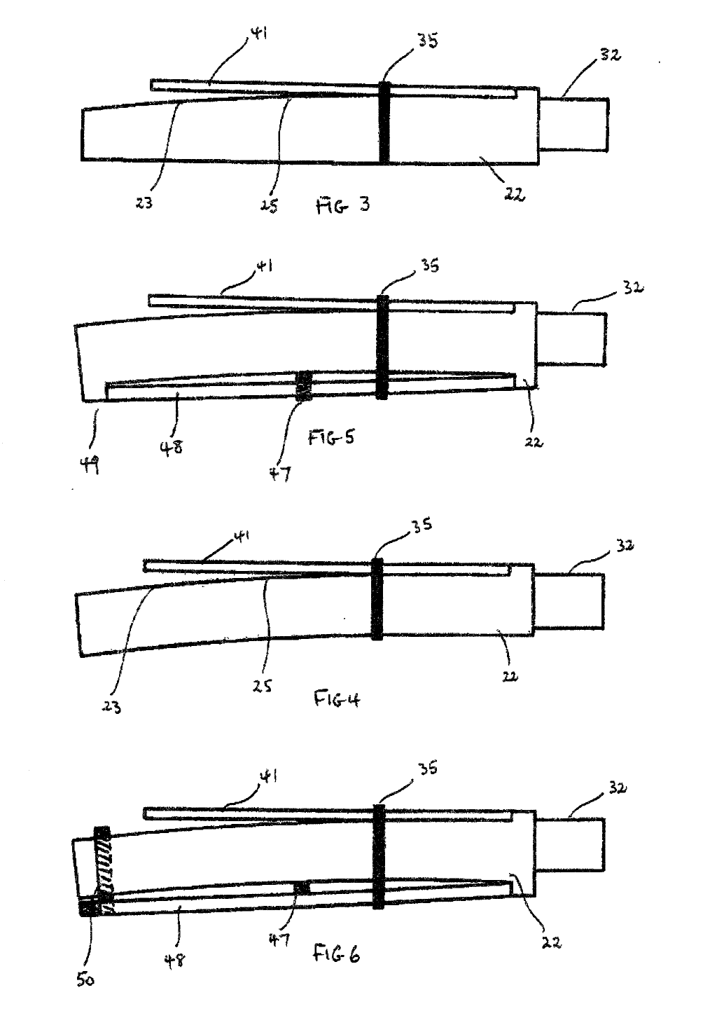

As shown in FIG. 4 the reed seat surface 23 can be a curved plane formed by the reed seat body 22 being substantially tabular around a curved central axis of rotation and the external reed surface 23 extends along the reed seat body 22 parallel to the central axis of rotation such that a planar reed 41 mounted over the bleed hole 25 extends away from the reed seat body 22. Simply immersing in hot water if made of plastic and bending to the appropriate curvature can achieve this change of curvature of the reed seat body 22. The amount of curvature can be selectively chosen in order to vary the air flow around the reed 41 and vary the pitch of sounds made by the drone.

In a further version shown by FIG. 5 the curvature of the reed seat body 22 can be selectively varied by use of a rigid plate 48 mounted in an inset 49 on the opposite side of the reed seat body 22 to the reed 41. The bagpipe reed system 11 includes a reed pitch adjustor 47 mounted on the rigid plate 48 and contacting an under surface of planar reed seat body 22 and adjustable to move the reed seat body 22 away from the rigid plate 48. The reed see adjustor 47 is a screw extending through the rigid plate 48. It has been found that the particular curvature of the reed seat body will substantially alter pitch. Therefore, the selection of the position of the reed pitch adjustor 47 on the rigid plate 48 will alter the pivot point and the curvature of the reed seat body 22.

In a still further system shown by FIG. 6, the reed system includes a reed pitch adjustor 47 mounted on a rigid body 48 and contacting a surface of the reed seat body 22 on an opposing side to the planar reed 41 and adjustable to curve the reed seat body 22 allowing the divergence of the reed 41 from the reed seat body 22. The rigid body 48 is selectively held at one end by a rigid body mount 50 and the reed seat adjustor 47 is a screw extending through the rigid body 48 and engaging the reed seat body 22 so that adjustment of the position of the rigid body mount 50 or the extension or position of the reed seat adjustor 47 alters the curvature of the reed seat body 22 and the divergence of the reed 41 from the reed seat body 22. This alters the tone or pitch of the instrument.

Another form of pitch adjustment is by a bridle 35 encircling the reed 41 and reed seat body 22 and slidable along the reed seat body 22 to force the reed 41 towards the diverging reed body 22. This system can be used in combination with any diverging reed body 22 and reed 41 systems.

The foregoing description should be considered as illustrative only of the principles of the invention, since numerous modifications and changes will readily occur to those skilled in the art, it is not desired to limit the invention to the exact construction and operation shown and described, and, accordingly, all suitable modifications and equivalents may be resorted to, falling within the scope of the invention. In addition, the invention is not intended to be limited to a specific limitation of the terms used, which have been selected to describe and define the invention, ad it is to be understood that each specific term includes all technical equivalents, which operate in a similar manner to accomplish a similar purpose.

I claim:

1. A bagpipe reed system comprising:
a reed seat body being substantially tubular with a bleed hole along one side and an open end connected or attachable to a bagpipe drone or chanter;
and a planar reed substantially overlying the bleed hole and held at one end by a reed mount to the reed seat body;
with the reed seat body having an external reed seat surface around the bleed hole which is shaped such that the planar reed diverges from the reed seat body.

2. A bagpipe reed system as claimed in claim 1 wherein said reed seat surge is a curved plane.

3. A bagpipe reed system as claimed in claim 1, wherein said reed seat body is a curved body allowing the divergence of the reed from the reed seat body.

4. A bagpipe reed system as claimed in claim 2, wherein the reed system includes a reed pitch adjustor mounted on a rigid body and contacting a surface of the reed se body or an opposing side to the planar reed and adjustable to curve the reed seat body allowing the divergence of the reed from the reed seat body.

5. A bagpipe reed system as claimed in claim 4, wherein said reed seat adjustor is a screw extending through a rigid plate hold within an inset of the reed seat body to form the rigid body and engaging the reed seat body.

6. A bagpipe reed system as claimed in claim 5, wherein said reed seat adjustor is a screw attachable at one of a number of positions on the rigid plate forming the rigid body and engaging the reed seat body so as to alter the pivot point and alter the curvature of the reed seat body.

7. A bagpipe reed system as claimed in claim 4 wherein said rigid body is selectively held at one end by a rigid body mount and the reed seat adjustor is a screw extending through the rigid body and engaging the reed seat body so that adjustment of the position of the rigid body mount or the extension or position of the reed seat adjustor alters the curvature of the reed seat body and the divergence of the reed from the reed scat body.

8. A bagpipe reed system as claimed in claim 1, wherein said reed system includes a bridle encircling the reed and reed seat body and slidable along the reed seat body to force the reed towards the diverging reed body.

9. A bagpipe reed system as claimed in claim 1, wherein said reed seat body is substantially tubular around a central axis of rotation and the external reed surface extends along the reed seat body inwardly towards the central axis of rotation such that a planar reed mounted over the bleed hole extends away from the reed seat body.

10. A bagpipe reed system as claimed in claim 1, wherein said reed seat body is substantially tubular around a curved central axis of rotation and the external reed surface extends along the reed seat body parallel to the central axis of rotation such that a planar reed mounted over the bleed hole extends away from the reed seat body.

11. A bagpipe reed system comprising:
a tubular body having two ends and an air bleed orifice,
a tuning plug adjustably mounted in one of said two ends of said tubular body to adjust the pitch,
a planar reed substantially overlying the bleed holes at held at one end by a reed mount to the reed seat body;
with the reed seat body having an external reed seat surface around the bleed hole shaped such that the planar reed extends non parallel to the reed seat body;
a reed pitch adjustor mounted on a rigid body having a torsional strength greater than the torsional strength of the reed seat body and contacting an opposing surface of the reed seat body to the reed and adjustable to move or deform the said reed seat body to diverge the reed from the reed seat body; and
a bridle encircling the reed and reed seat body and slidable along the reed seat body to force the reed towards the diverging reed body.

12. A bagpipe reed system as claimed in claim 11, wherein said reed seat adjustor s a screw extending through the reed seat body and engaging the reed.

13. A bagpipe instrument comprising: a reed seat body being substantially tubular with a bleed hole along one side and an open end connected or attachable to a bagpipe drone or chanter, and a reed substantially overlying the bleed hole and held at one end by a reed mount to the reed seat body and the reed system including a reed pitch adjustor mounted on the reed seat body and contacting a surface of the reed seat body to deform the reed seat body and thereby adjust the pitch or tone of the instrument.

14. A bagpipe instrument as claimed in claim 13, wherein the deformity of the reed seat body allows the reed to diverge away from the reed seat body to adjust the pitch or tone of the instrument.

15. A bagpipe instrument as claimed in claim 13, wherein, the reed pitch adjustor is able to selectively alter the deformity of the reed seat body to adjust the pitch or tone of the instrument.

16. A method of altering the pitch or tone of a bagpipe instrument by altering the curvature of a reed seat body having an air bleed hole and able to receive a reed mounted over the bleed hole.
